(19) United States
(12) Patent Application Publication
(10) Pub. No.: US 2015/0161540 A1
(43) Pub. Date: Jun. 11, 2015

(54) Automatic Road Condition Detection

(71) Applicant: International Business Machines Corporation, Armonk, NY (US)

(72) Inventors: Ben Z. Akselrod, Toronto (CA); Anthony Di Loreto, Markham (CA); Steve McDuff, Markham (CA); Kyle Robeson, North York (CA)

(73) Assignee: International Business Machines Corporation, Armonk, NY (US)

(21) Appl. No.: 14/098,582

(22) Filed: Dec. 6, 2013

(51) Int. Cl. G06Q 10/06

(52) U.S. Cl. CPC G06Q 10/06311

(57) ABSTRACT

Monitoring road conditions and prioritizing and/or requesting real-time repair work performed, such as weather-related repair work to address “fixable conditions.” Some embodiments perform the following actions (not necessarily in the following order): (i) monitoring machines connected in data communication to a communication network, covering multiple roads, in a common local area (such as a city), respectively for a “fixable condition”; (ii) detecting multiple fixable conditions on the multiple roads; and (iii) creating, by machine logic and based in part on the detected fixable conditions, an initial prioritized schedule for application of road maintenance resources to the roads.

### BACKGROUND OF THE INVENTION

The present invention relates generally to the field of weather and/or road condition surveillance, detection, and/or response (herein called “road condition detection”) and more particularly to road condition detection multiple roads geographically distributed over a “local area” (for example, a large city or a rural county). Conventionally, roads (see Definition, below) may be obstructed by snow, ice, leaves, or any other obstruction and/or road damage requiring professional service, human road condition detection is usually required to: (i) determine that “road service” (see definition, below) is needed; (ii) summon the road service resources; and (iii) triage road service resources when such services are needed in multiple places at the same time.

When cities face emergency situations such as earthquakes, floods, and snowstorms, the entire city paved areas can be affected. Such incidents typically require (i), (ii), and (iii) for every road in the entire city. This can be costly in both time and money for those tasked with such cleanup.

### SUMMARY

According to an aspect of the present invention, there is a computer program product, system, and/or method that performs the following actions (not necessarily in the following order): (i) monitoring machines connected in data communication to a communication network, covering multiple roads, in a common local area, respectively for a fixable condition; (ii) detecting a plurality of fixable conditions on multiple roads; and (iii) creating, by machine logic and based in part on the detected fixable conditions, an initial prioritized schedule for application of road maintenance resources to the roads.

### BRIEF DESCRIPTION OF THE SEVERAL VIEWS OF THE DRAWINGS

FIG. 1 is a schematic view of a first embodiment of a networked computers system according to the present invention;

FIG. 2 is a schematic view of a sub-system of the first embodiment system;

FIG. 3 is a flowchart showing a method performed, at least in part, by the first embodiment system; and

FIG. 4 is a schematic view of a software portion of the first embodiment computer system.

### DETAILED DESCRIPTION

This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module” or “system”. Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object-oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

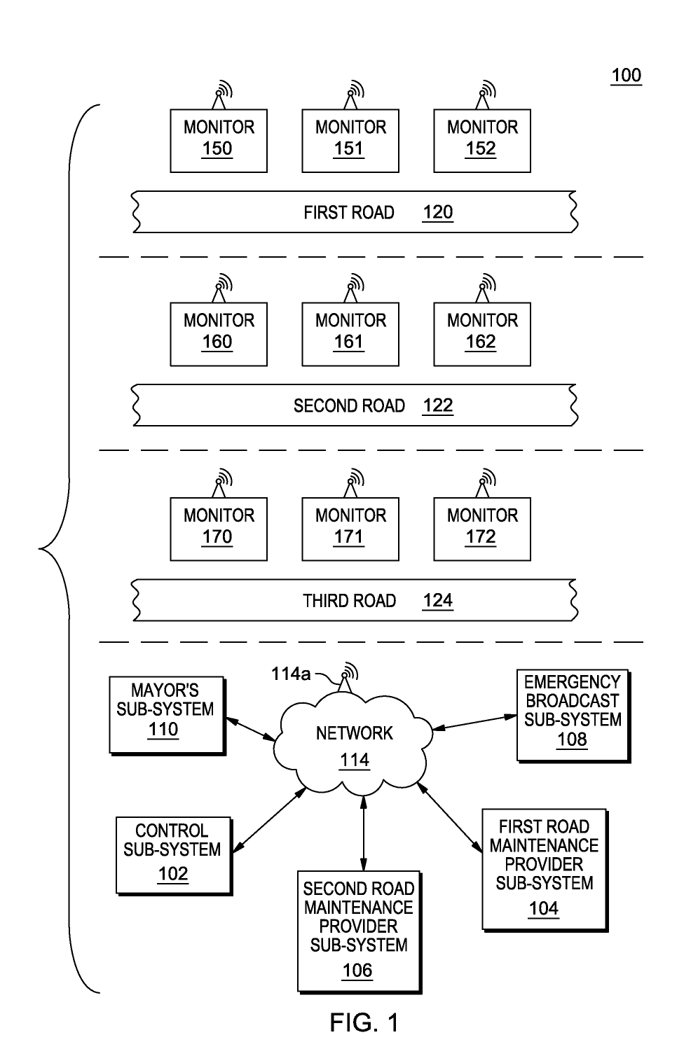

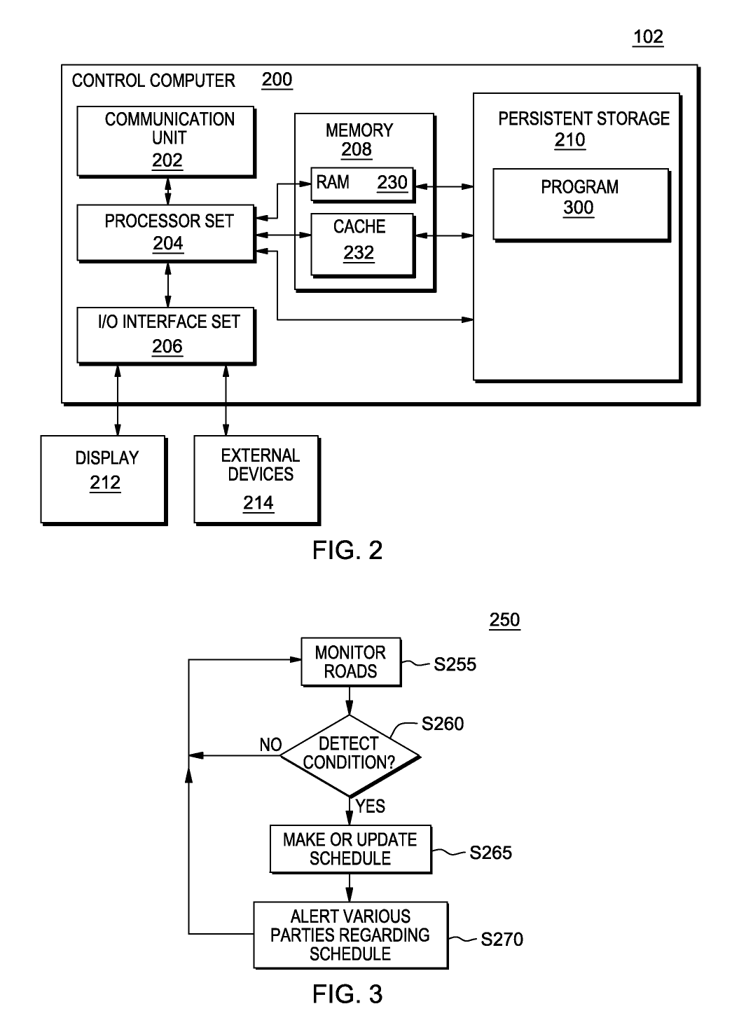

An embodiment of a possible hardware and software environment for software and/or methods according to the present invention will now be described in detail with reference to the Figures. FIGS. 1 and 2 collectively make up a functional block diagram illustrating various portions of networked computers system 100, including: control sub-system 102; first road maintenance provider sub-system 104; second road maintenance provider sub-system 106; emergency broadcast sub-system 108; mayor's sub-system 110; communication network 114 (including wireless transceiver 114a); roads 120, 122, 124; and monitor stations 150, 151, 152, 160, 161, 162, 170, 171, 172. Control sub-system 102 includes: control computer 200; communication unit 202; processor set 204; input/output (i/o) interface set 206; memory device 208; persistent storage device 210; display device 212; external device set 214; random access memory (RAM) devices 230; cache memory device 232; and program 300.

As shown in FIG. 2, sub-system 102 is, in many respects, representative of the various computer sub-system(s) in the present invention. Accordingly, several portions of sub-system 102 will now be discussed in the following paragraphs.

Sub-system 102 may be a laptop computer, a tablet computer, a netbook computer, a personal computer (PC), a desktop computer, a personal digital assistant (PDA), a smart phone, or any programmable electronic device capable of communicating with the client sub-systems via network 114. Program 300 is a collection of machine-readable instructions and/or data that is used to create, manage, and control certain software functions that will be discussed in detail, below, in the Example Embodiment sub-section of this Detailed Description section.

Sub-system 102 is capable of communicating with other sub-systems via network 114. Network 114 can be, for example, a local area network (LAN), a wide area network (WAN), such as the Internet, or a combination of the two, and can include wired, wireless, or fiber optic connections. In general, network 114 can be any combination of connections and protocols that will support communications between server and client sub-systems.

It should be appreciated that FIGS. 1 and 2, taken together, provide only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications, and the like.

As shown in FIG. 2, sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications, and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors of processor set 204, usually through one or more memories of memory 208. Persistent storage 210: (i) is at least more persistent than a signal in transit; (ii) stores the program (including its soft logic and/or data) on a tangible medium (such as magnetic or optical domains); and (iii) is substantially less persistent than permanent storage. Alternatively, data storage may be more persistent and/or permanent than the type of storage provided by persistent storage 210.

Program 300 may include both machine-readable and performable instructions and/or substantive data (that is, the type of data stored in a database). In this particular embodiment, persistent storage 210 includes a magnetic hard disk drive. To name some possible variations, persistent storage 210 may include a solid-state hard drive, a semiconductor storage device, a read-only memory (ROM), an erasable programmable read-only memory (EPROM), a flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communication unit 202, in these examples, provides for communications with other data processing systems or devices external to sub-system 102, such as sub-systems 104, 106, 108, and 110. In these examples, communication unit 202 includes one or more network interface cards. Communication unit 202 may provide communications through the use of either or both physical and wireless communications links. Any software modules discussed herein may be downloaded to a persistent storage device (such as persistent storage 210) through a communications unit (such as communication unit 202).

I/O interface set 206 allows for input and output of data with other devices that may be connected locally in data communication with control computer 200. For example, I/O interface set 206 provides a connection to external device set 214. External device set 214 will typically include devices such as a keyboard, a keypad, a touch screen, and/or some other suitable input device. External device set 214 can also include portable computer-readable storage media such as, for example, thumb drives, portable optical, or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage 210 via I/O interface set 206. I/O interface set 206 also connects in data communication with display 212.

Display 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus, the invention should not be limited to use solely in any specific application identified and/or implied by such nomenclature.

### II. EXAMPLE EMBODIMENT

Preliminary note: The flowchart and block diagrams in the following Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or combinations of special purpose hardware and computer instructions.

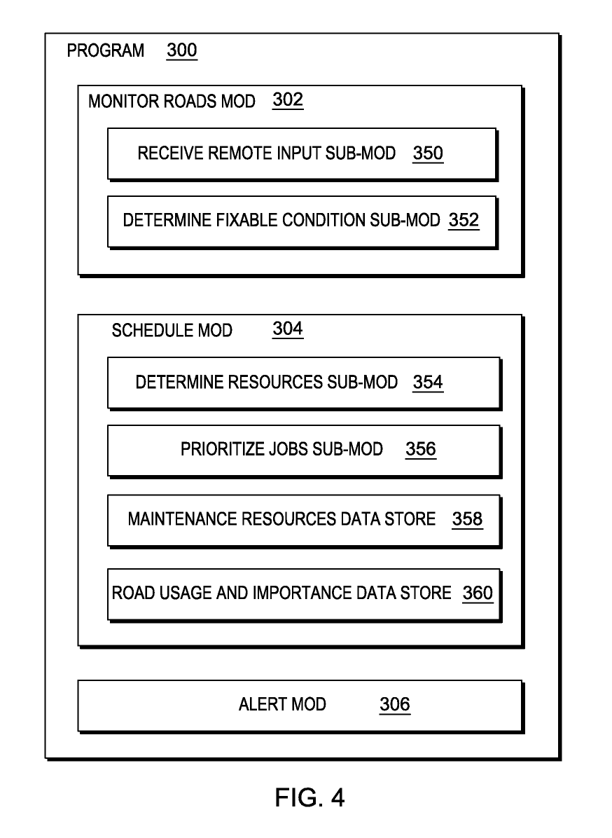

FIG. 3 shows a flow chart 250 depicting a method according to the present invention. FIG. 4 shows program 300 for performing at least some of the method steps of flow chart 250. This method and associated software will now be discussed, over the course of the following paragraphs, with extensive reference to FIGS. 3 (for the method step blocks) and FIG. 4 (for the software blocks).

Processing begins at step S255 where receive remote input sub-module (“sub-mod”) 350 of monitor roads mod 302 of program 300 of control sub-system 102 receives, through network 114, information about condition of roads 120, 122, and 124 from monitor stations 150, 151, 152, 160, 161, 162, 170, 171, and 172 (see FIGS. 1, 2, and 4). Roads (see definition in definitions sub-section, below) 120, 122, and 124 are all roads in the same local area (see definition, below, in Definitions sub-section). As shown in FIG. 1: (i) monitor stations 150, 151, and 152 are in proximity to and monitor the condition of road 120; (ii) monitor stations 160, 161, and 162 are in proximity to and monitor the condition of road 122; and (iii) monitor stations 170, 171, and 172 are in proximity to and monitor the condition of road 124. In other embodiments, there would be more roads, of various types, and more monitoring stations. In this embodiment, the monitoring stations are stationary. Alternatively, other embodiments may use moving monitoring devices (in whole or in part).

In this embodiment, the monitoring of the roads is performed by means of capturing and analyzing successive visual images. Alternatively, and/or additionally, other embodiments may use sound waves, chemical detectors, contact sensors, and/or other types of road condition sensing equipment (now known or to be developed in the future) to monitor the road condition. The monitoring of the road is designed to automatically, and without the need for human reporting, detect conditions that would stop, or severely impair the flow of traffic over the road (for example, the flow of foot traffic over a busy sidewalk). In this embodiment, the monitoring stations merely send raw visual image data to program 300 of control sub-system 102 over communication network 114. Alternatively, the monitoring stations themselves could perform processing to detect “fixable conditions” (see definition, below, in the Definitions sub-section) that come to exist in the various roads of the local area.

Processing proceeds to step S260, where determine fixable condition sub-mod 352 of monitor roads mod 302 of program 300 uses data received at step S255 to detect that a fixable condition has arisen in one of the roads. Fixable condition sub-mod 352 also detects other ancillary information, such as the nature of the fixable condition, the severity of the fixable condition, and the location of the fixable condition. If no new fixable condition is detected at step S260, then processing loops back to step S255.

If a new fixable condition is detected at step S260, then processing proceeds to step S265 where schedule mod 304 makes and/or updates a road maintenance schedule for fixing the fixable conditions detected by the monitoring of the roads. More specifically: (i) determine resources sub-mod 354 determines what road maintenance resources (for example, people and/or equipment) are needed to fix the newly-detected fixable condition with reference to the resources listed in maintenance resources data store 358; and (ii) prioritize jobs sub-mod 356 prioritizes and/or re-prioritizes the fixable conditions that have been detected with reference to the data in road usage and importance data store 360.

Processing proceeds to step S370, where alert mod 306 of program 300 alerts interested parties, through network 114, of the prioritized road maintenance schedule. In this embodiment, these alerts occur automatically and substantially without human intervention. In this example and as shown in FIG. 1, the interested parties are the people respectively attending to the following sub-systems: first road maintenance provider sub-system 104; second road maintenance provider sub-system 106; emergency broadcast sub-system 108; and mayor's sub-system 110. After the update schedule is communicated to the interested parties, processing loops back to step S255.

### III. FURTHER COMMENTS AND/OR EMBODIMENTS

Some embodiments of the present invention include one, or more, of the following features, characteristics, and/or embodiments: (i) detect road conditions; (ii) alert service providers on changes requiring professional service; (iii) detect completion of “road work” (see, Definition, below); and/or (iv) monitor different events such as snow, ice, pot hole formation, cracks, leaves, or other “serviceable road condition” (see, definition, below); (v) system includes multiple cameras, multiple sensors, and an embedded computing device; (vi) a computing device measures road conditions, such as accumulation of snow, accumulation of ice, accumulation of leaves, pot hole formation, and/or cracks; (vii) cameras use existing motion sensing, or land surveying technology, to create a 3 d (three dimensional) topographical image of a non-serviceable road as a baseline and, then, monitors changes at a regular time interval; (viii) additional cameras can capture changes in color; (ix) once enough snow (or other potential obstruction) accumulates, the system can detect the event based on a change on a topographical 3 d image and/or its color(s); (x) system defines minimum threshold for serviceable road condition (for example, snow accumulation) such that serviceable road condition requires road work; (xi) can be manually set depending on home owner or service provider preferences; (xii) monitor completion of road service in order to allow service providers to automatically track which clients have been served; (xiii) serve a variety of potential markets such as municipalities; and/or (xiv) ability to detect serviceable that require services such as deicing and/or snow removal.

In some embodiments, when a serviceable road condition threshold is crossed, the system may be programmed to respond in a variety of ways, such as, but not limited to: (i) alerting the home owner through a visual, audio, or other indicator; (ii) sending a phone text or message to the owner; (iii) alerting the professional service; (iv) scheduling an appointment to fix the issue with a service provider; and/or (v) addressing the serviceable road condition issue directly, if possible.

Some embodiments of the present invention may include one, or more, of the following features, characteristics, and/or advantages: (i) detects paved surface conditions, such as paved roads, paths, bridges, etc.; (ii) aggregates multiple roads into a single structure; (iii) prioritizes (or “triages”) road services based upon factors such as severity of condition, typical volume of traffic on the road, ability for the serviceable road condition to resolve itself without road service (for example, flooded road way will eventually drain, but an alert should be dispatched); (iv) provides an aggregated city-wide view; (v) prioritization scheme sent automatically to local government or local emergency response teams on changes requiring service; (vi) is updated and has a relatively low latency (for example acts in real time) so that as work is completed, remaining serviceable road conditions will get re-prioritized or removed accordingly; (vii) monitors different events such as, but not limited to, snow, ice, pot hole formation, cracks, floods, earthquake damage, or other road damages; and/or (viii) prioritizes road repair based on factors such as severity of damage, usage statistics, and typical traffic patterns.

Some embodiments of the present invention may include one, or more, of the following features, characteristics, and/or advantages: (i) system includes multiple cameras, sensors, land surveying tools, or other measurement equipment connected to a centralized computing device; (ii) uses computing device to measure, or approximate, road conditions such as flooding, road damage due to earthquakes, sink hole, road upheaval due to water build up, accumulation of snow, accumulation of ice, accumulation of leaves, pothole formation, and road cracks; (iii) a minimum serviceable road condition threshold can be manually set, or adjusted, depending on severity; (iv) based upon detection of a serviceable road condition, the system alerts a human crew with information, such as the identity of current threats or disaster areas; (v) automatically, and substantially without human intervention, dispatches teams to key areas; (vi) alerts of serviceable road conditions with information including severity information and recommended actions; (vii) list of road servicing prioritization is updated with relatively low latency (for example, in real time) based upon the sampling rate of the sensors equipment; and/or (viii) automatically, and without substantial human intervention, updates a “situational response plan.”

Some embodiments of the present invention may include one, or more, of the following features, characteristics, and/or advantages: (i) aggregates multiple events in a disaster scenario for an emergency team to handle; (ii) does not necessarily use human report, but, rather, uses sensors and other methods of detection; (iii) prioritizes multiple events to handle them in an emergency situation; (iv) looks at a city-wide (or large area) set of data for road ways which is used in disaster scenarios and for which there may be insufficient resources to handle all events immediately and simultaneously; (v) updates in real time, including handling of “actions” done to solve a problem; (vi) dispatches an emergency worker to direct traffic, and accordingly updates the system in real time to alter its prioritization even if the root sensors are still showing issues; (vii) informs an emergency worker what needs to be done at the site, which goes beyond merely giving the emergency worker a location and picture; and/or (viii) uses detection of the surfaces of roads to create a city-wide picture in an emergency situation and/or city-wide prioritization of resource allocation directed to solving the detected and prioritized problems; (ix) encompasses any type of situation that would cause a city to require emergency response on a large level which includes, but is not necessarily limited to, flooding, tornadoes, terrorist attacks, earthquake, fires, sink holes, etc.; (x) solves and reacts to extreme road conditions on a city-wide level; (xi) using topographical map data covering a city-wide or large geographical area; and/or (xii) amalgamating road condition images (for example, 2D camera images).

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention”, is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B, “and/or” C means that at least one of A or B or C is true and applicable.

Data communication: any sort of data communication scheme now known or to be developed in the future, including wireless communication, wired communication, and communication routes that have wireless and wired portions; data communication is not necessarily limited to: (i) direct data communication; (ii) indirect data communication; and/or (iii) data communication where the format, packetization status, medium, encryption status, and/or protocol remains constant over the entire course of the data communication.

Software storage device: any device (or set of devices) capable of storing computer code in a manner less transient than a signal in transit.

Tangible medium software storage device: any software storage device (see Definition, above) that stores the computer code in and/or on a tangible medium.

Non-transitory software storage device: any software storage device (see Definition, above) that stores the computer code in a non-transitory manner.

Computer: any device with significant data processing and/or machine-readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, and application-specific integrated circuit (ASIC) based devices.

Road: includes any outdoor land passageway structure designed for vehicular, pedestrian, and/or robotic traffic; some examples of “roads’ include: sidewalks, driveways, and highways for motor vehicles, roads for motor vehicles, jogging tracks, walking paths, unpaved roads, runways, docks, parking lots, parking structures, bridges, etc; while “road” is a very inclusive concept, it is noted that not every road in a “local area” (see definition, below) needs to be including in a local area monitoring scheme according to the present invention.

Fixable condition: a problem with a road that is fixable by application of road maintenance resources, such as leaf removal, debris removal, snow removal, ice removal, hazardous waste removal, firefighting crews and equipment, re-paving resources, regarding resources, tree and log removal resources, traffic control device maintenance, accident response paramedics, flooding cleanup, ruptured gas line response resources, tow trucks, etc.

Local area: an area that is substantially cohesive with respect to the sharing of road maintenance resources; for example, Anchorage, Ak. and Toronto, Canada are not in the same “local area” because they are too far apart to share snow plows and other road maintenance services.

Relatively low latency: sufficiently low latency such that the latency would not have any substantial and meaningful impact on the timeliness of providing road maintenance, or making changes in a schedule for road maintenance; for example, a ten second latency time would be an example of relatively low latency.

What is claimed is:

1. A method comprising:
monitoring, by monitoring machines connected in data communication to a communication network, a plurality of roads, in a common local area, respectively for a fixable condition;
detecting a plurality of fixable conditions on the plurality of the roads; and
creating, by machine logic and based in part on the detected fixable conditions, an initial prioritized schedule for application of road maintenance resources to the roads.

2. The method of claim 1 wherein the detecting of a plurality of fixable conditions is subject to relatively low latency.

3. The method of claim 1 further comprising:
subsequent to creation of the initial prioritized schedule, updating the plurality of fixable conditions with a newly detected fixable condition; and
updating, by machine logic and based in part on the newly detected fixable condition, an updated prioritized schedule for application of road maintenance resources to the roads.

4. The method of claim 1 wherein the monitoring includes at least one of the following types of monitoring: visual detection, motion detection, and/or chemical detection.

5. The method of claim 4 wherein:
the monitoring includes visual detection; and
the visual detection comprises:
creating a three-dimensional topographical image of each road of the plurality of roads.

6. The method of claim 1 further comprising:
sending an alert to a first road maintenance providing entity, with the alert being based, at least in part, on the initial prioritized schedule.

7. The method of claim 1 further comprising:
updating the prioritized schedule to reflect fixing of a first fixable condition on a first road of the plurality of roads.

8. A computer program product comprising a software storage device and software stored on the software storage device, the software comprising:
first program instructions programmed to monitor machines connected in data communication to a communication network, a plurality of roads, in a common local area, respectively for a fixable condition;
second program instructions programmed to detect a plurality of fixable conditions on a plurality of the roads; and
third program instructions programmed to create, based in part on the detected fixable conditions, an initial prioritized schedule for application of road maintenance resources to the roads;
wherein the software is stored on a software storage device in a manner less transitory than a signal in transit.

9. The product of claim 8 wherein the second program instructions are further programmed to detect of the plurality of fixable conditions with relatively low latency.

10. The product of claim 8 wherein the software further comprises:
fourth program instructions programmed to, subsequent to creation of the initial prioritized schedule, update the plurality of fixable conditions with a newly detected fixable condition; and
fifth program instructions programmed to update, based in part on the newly detected fixable condition, an updated prioritized schedule for application of road maintenance resources to the roads.

11. The product of claim 8 wherein the first program instructions are further programmed to perform at least one of the following types of monitoring: visual detection, motion detection, and/or chemical detection.

12. The product of claim 11 wherein the software further comprises:
the first program instructions are further programmed to perform visual detection; and
the visual detection comprises:
creating a three-dimensional topographical image of each road of the plurality of roads.

13. The product of claim 8 wherein the software further comprises:
sending an alert to a first road maintenance providing entity, with the alert being based, at least in part, on the initial prioritized schedule.

14. The product of claim 8 wherein the software further comprises:
fourth program instructions programmed to update the prioritized schedule to reflect fixing of a first fixable condition on a first road of the plurality of roads.

15. A computer system comprising:
a processor(s) set; and
a software storage device;
wherein:
the processor set is structured, located, connected, and/or programmed to run software stored on the software storage device; and
the software comprises:
first program instructions programmed to monitor machines connected in data communication to a communication network, a plurality of roads, in a common local area, respectively for a fixable condition;
second program instructions programmed to detect a plurality of fixable conditions on a plurality of the roads; and
third program instructions programmed to create, based in part on the detected fixable conditions, an initial prioritized schedule for application of road maintenance resources to the roads.

16. The system of claim 15 wherein the second program instructions are further programmed to detect of the plurality of fixable conditions with relatively low latency.

17. The system of claim 15 wherein the software further comprises:
fourth program instructions programmed to, subsequent to creation of the initial prioritized schedule, update the plurality of fixable conditions with a newly detected fixable condition; and
fifth program instructions programmed to update, based in part on the newly detected fixable condition, an updated prioritized schedule for application of road maintenance resources to the roads.

18. The system of claim 15 wherein the first program instructions are further programmed to perform at least one of the following types of monitoring: visual detection, motion detection, and/or chemical detection.

19. The system of claim 18 wherein the software further comprises:
the first program instructions are further programmed to perform visual detection; and
the visual detection comprises:
creating a three-dimensional topographical image of each road of the plurality of roads.

20. The system of claim 15 wherein the software further comprises:
sending an alert to a first road maintenance providing entity, with the alert being based, at least in part, on the initial prioritized schedule.
